(19) United States
(12) Patent Application Publication
(10) Pub. No.: US 2015/0334019 A1
(43) Pub. Date: Nov. 19, 2015

(54) ROUTING CONTROL METHOD AND NON-TRANSITORY COMPUTER-READABLE RECORDING MEDIUM STORING ROUTING CONTROL PROGRAM

(71) Applicant: Hitachi, Ltd., Tokyo (JP)

(72) Inventors: Ryuichi SAITO, Tokyo (JP); Kazuhiro KUSAMA, Tokyo (JP); Mitsuru NAKAMURA, Tokyo (JP)

(21) Appl. No.: 14/705,036

(22) Filed: May 6, 2015

(30) Foreign Application Priority Data
May 16, 2014 (JP) 2014-101915

(51) Int. Cl. H04L 12/741; H04L 12/18

(52) U.S. Cl. CPC H04L 45/745; H04L 12/18

(57) ABSTRACT

In a network in which a plurality of communication terminals and at least one server are connected through at least one router, when a network controller, configured to control the network and having a control function of routing of the at least one router in the network and routing information of the at least one router the network, receives an event which changes a destination address of the at least one server, the network controller primarily controls routing information which does not affect a communication being connected and after the processing of changing the destination address has been completed, controls routing information which affects a communication during connecting.

### CROSS-REFERENCE TO RELATED APPLICATION

This application claims the priority of Japanese Patent Application No. 2014-101915 filed May 16, 2014, which is incorporated herein by reference in its entirety.

### BACKGROUND OF THE INVENTION

1. Field of the Invention

The present invention relates to a routing control technique, and more specifically, relates to a technique which controls route switching, in a network in which a large number of communication terminals and a server are connected, so that the communication between the server and the communication terminal is not disconnected (a transmission control protocol (TCP) is not disconnected, and an application is not timed out).

2. Description of the Related Art

Recently, as communication terminals, such as mobile phones, are widespread, the number of connections between a server and a large number of communication terminals have been increasing. In view of the foregoing, a technique of load distribution, by visualizing a server and assigning processing of a server with heavy load to a server with a light load, is known. When the load distribution is performed, a failure occurs in a server, or a live migration is performed, processing performed in a virtual machine operating in a server is moved to another virtual machine operating in another server, that is, a server migration is performed. However, in the server migration, there are problems that the migration takes long time and disconnection occurs due to the change of a connection destination.

A technique to shorten a processing time of a live migration is disclosed in JP 2012-175190 A. According to JP 2012-175190 A, when it is detected that the live migration is started, a setting to construct a route to access a virtual machine installed in a virtual private network (VPN) as a destination of the live migration is performed to a predetermined network device in parallel with the detection, then, when it is detected that the live migration is completed and the setting to the network device is completed, the current route is switched to the constructed route.

Furthermore, a technique disclosed in WO 2005/083569 A provides to continue a service without restoration processing by a user when a server is switched. When a process migration from a first server to a second server is performed, server/network cooperation control unit receives a request of the process migration from the first server to the second server and transmits the request of the process migration including second server information as the destination to operating server switching control unit. Then, the server/network cooperation control unit receives the completion notification of the process migration from the operating server switching control unit and transmits a request of network-switching from a first network to a second network including the second network information to connection control unit. Accordingly, the connection control unit switches the target network from the first network to the second network.

### SUMMARY OF THE INVENTION

In the above WO 2005/083569 A, as the information of the second network as the migration destination, a virtual local area network (VLAN) ID is notified and a routing table is statically held. Furthermore, in JP 2012-175190 A, the network device to set a route is not assumed that a plurality of devices are used and route switching of a network in which a large number of communication terminals and a virtual machine on a server are connected through a plurality of routers is not disclosed.

In a network in which a server (including a virtual machine (VM)) and a large number of communication terminals are connected, following problems should be solved to perform a server migration without affecting the communication of the communication terminal.

Although the server migration is performed without changing an internet protocol (IP) address of the server so as not to change a setting of the communication terminal before and after the server migration, a great deal of routing information needs to be changed since a large number of the communication terminals are associated with the IP address of the server.

When such route switching processing is performed accompanying the change of a great deal of routing information, for example, it is possible to perform the switching in a few seconds, but it is difficult to perform the switching in a very short time, such as within 0.5 to 1 seconds, based on a routing protocol. When the route switching takes time in seconds, packet loss between the server and the communication terminal occurs and problems that a TCP is disconnected and an application is timed out occur.

The present invention is to solve the above problems, and the purpose thereof is to control route switching, in a network connected with a large number of communication terminals, so that the communication between a server and a communication terminal is not disconnected (a transmission control protocol (TCP) is not disconnected, and an application is not timed out).

To solve the above problems, as an example of the present invention, in a network in which a plurality of communication terminals and at least one server are connected through at least one router, a network controller is configured to control the network and has routing information of the at least one router in the network and a function to control the routing information of the at least one router in the network. When the network controller receives an event which changes a destination address of the at least one server, the network controller primarily controls routing information which does not affect a communication being connected and after the processing of changing the destination address has been completed, the network controller controls routing information which affects a communication being connected.

Furthermore, as another example of the present invention, the network controller primarily sets routing information of a downstream route which does not affect a communication being connected and sets, to routing information of an upstream route, the routing information in which the destination address has been changed such that the routing information is not received, and after the processing of changing the destination address has been completed, the network controller controls a state capable of receiving the routing information, in which the destination address has been changed, of the upstream route.

The present invention can control route switching, in a network connected with a large number of communication terminals, so that the communication between a server and a communication terminal is not disconnected (a transmission control protocol (TCP) is not disconnected, and an application is not timed out).

### BRIEF DESCRIPTION OF THE DRAWINGS

FIG. 1 is a diagram showing a system configuration of an embodiment of the present invention;

FIG. 2 is a diagram showing a hardware configuration of a network controller and a server of an embodiment of the present invention;

FIG. 3 is a diagram showing a software configuration of the network controller of an embodiment of the present invention;

FIG. 4 is a diagram showing state transition of the network controller of an embodiment of the present invention;

FIG. 5 is a sequence diagram showing processing from a VM migration request to downstream route learning completion of an embodiment of the present invention;

FIG. 6 is a sequence diagram showing processing from a VM copying completion response to an upstream route learning start of an embodiment of the present invention;

FIG. 7 is a sequence diagram showing processing from upstream route learning completion waiting to a VM switching completion response of an embodiment of the present invention;

FIG. 8 is a sequence diagram showing processing from an unnecessary route deletion request to a VM migration completion response of an embodiment of the present invention;

FIG. 9 is a diagram showing an example of a VM operating state/IP routing state management table held by the network controller;

FIG. 10 is a diagram showing an example of a topology management table held by the network controller;

FIG. 11 is a diagram showing an example of setting information and a routing table held by an access router in an initial state;

FIG. 12 is a diagram showing an example of setting information and a routing table held by a center router in an initial state;

FIG. 13 is a diagram showing an example of setting information held by the center router at downstream route learning and a routing table of the center router after downstream route learning;

FIG. 14 is a diagram showing an example of setting information held by the access router at upstream route learning and a routing table of the access router after upstream route learning;

FIG. 15 is a diagram showing an example of setting information held by the center router at upstream route learning and a routing table of the center router after upstream route learning;

FIG. 16 is a diagram showing an example of setting information held by the access router at unnecessary route deletion and a routing table of the access router after unnecessary route deletion;

FIG. 17 is a diagram showing an example of setting information held by the center router at unnecessary route deletion and a routing table of the center router after unnecessary route deletion;

FIG. 18 is a flowchart showing processing when a VM migration start request event is received in an initial state of an embodiment of the present invention;

FIG. 19 is a flowchart showing downstream learning completion determination, processing of an embodiment of the present invention;

FIG. 20 is a flowchart showing processing when a VM copying completion event of an embodiment of the present invention is received;

FIG. 21 is a flowchart showing processing when a downstream route learning completion event of an embodiment of the present invention is received;

FIG. 22 is a flowchart showing processing when a VM switching request and an upstream route learning request of an embodiment of the present invention are issued;

FIG. 23 is a flowchart showing upstream route learning completion determination processing of an embodiment of the present invention;

FIG. 24 is a flowchart showing processing when a VM switching completion event of an embodiment of the present invention is received;

FIG. 25 is a flowchart showing processing when an upstream route learning completion event of an embodiment of the present invention is received;

FIG. 26 is a flowchart showing processing when an unnecessary route deletion request of an embodiment of the present invention is received;

FIG. 27 is a flowchart showing routing configuration request (deletion) completion determination processing of an embodiment of the present invention; and

FIG. 28 is a flowchart showing processing when a routing configuration request (deletion) completion event of an embodiment of the present invention is received.

### DESCRIPTION OF THE PREFERRED EMBODIMENTS

### First Embodiment

Hereinafter, embodiments will be described. The embodiments perform route switching simultaneously by learning and setting a network route beforehand and performing a live migration of a server at the same time so that the communication between a server and a communication terminal is not disconnected (a transmission control protocol (TCP) is not disconnected, and an application is not timed out).

In the embodiments, a user (network manager) requests, as a migration destination of a virtual machine ID (VMID) 0001 on a migration source server 1, information of a migration destination physical server 2 from a network controller.

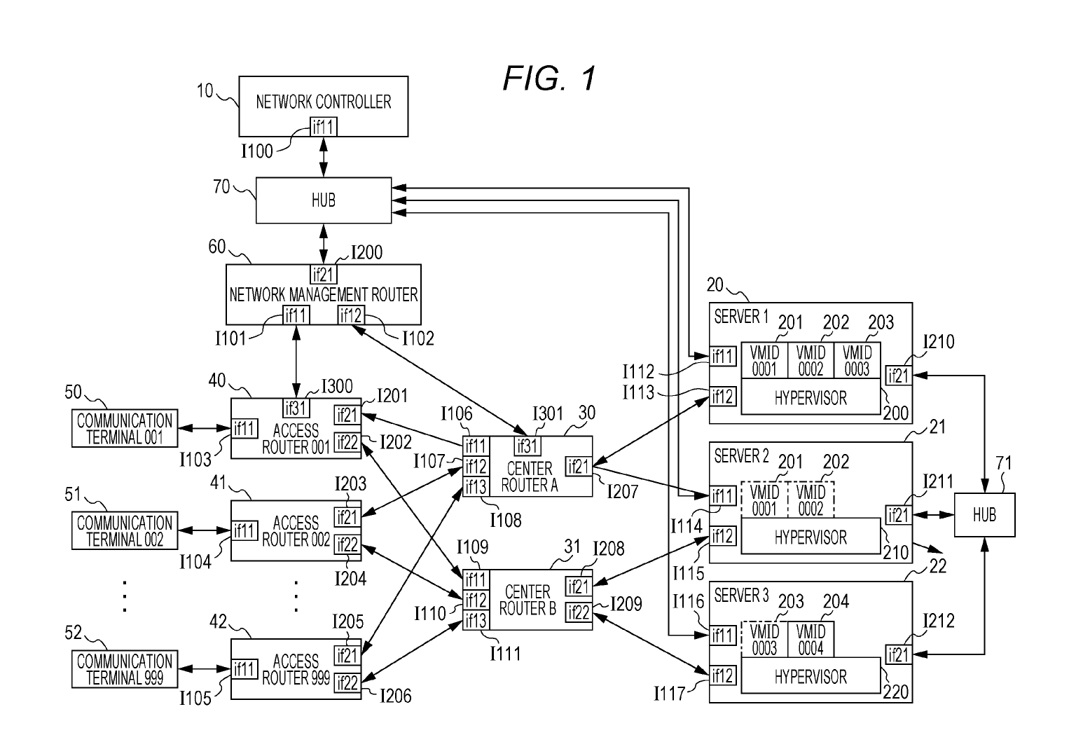

FIG. 1 is a diagram showing a system configuration of an embodiment of the present invention.

In FIG. 1, a server 1 (20), a server 2 (21), a server 3 (22), and a network management router (60) are connected to a network controller (10) through a hub (HUB) (70).

A communication terminal 001 (50) is connected to a VMID0001 (201) constructed on a hypervisor (200) of the server 1 (20) through an access router 001 (40) and a center router A (30). Similarly, a communication terminal 002 (51) to a communication terminal 999 (52) are connected to the VMID0001 (201) to a VMID0004 (204) on the server 1 (20) to the server 3 (22) through an access router 002 (41) to an access router 999 (42). In the embodiments, although an example in which the connection relation between the communication terminal and the access router is 1:1 is described, it is possible that the connection relation is n:1 and the connection method is not limited.

The network controller (10) is connected to the network management router (60) through the HUB (70). The network management router (60) is connected to the communication terminal 001 (50) to the communication terminal 999 (52), the access router 001(40) to the access router 999 (42), and the center router A (30) and a center router B (31) through the access router 001 (40) and the center router A (30). The server 1 (20), the server 2 (21), and the server 3 (22) are connected to each other through a HUB (71) and able to transmit and receive data.

The network controller (10), the network management router (60), the communication terminal 001 (50) to the communication terminal 999 (52), the access router 001 (40) to the access router 999 (42), the center router A (30) to the center router B (31), and the server 1 (20) to the server 3 (22) have a network interface if11 (I100) to an if31 (I301) and are connected to each other through the network interfaces. For example, the communication route between the communication terminal 001 (50) and the VMID0001 (201) is established by passing through in the order of the communication terminal 001 (50), an if11 (I103) and an if21 (I201) of the access router 001 (40), an if11 (I106) and an if21 (I207) of the center router A (30), an if12 (I113) of the server 1 (20), and the hypervisor (200).

The communication route of FIG. 1 shows an example and the connection method is not limited. For example, another router may be connected between the access router 001 (40) and the center router A (30). Furthermore, although the network controller (10) is connected to the access router 001 (40) and the center router A (30) through the network management router (60), the system can be implemented by various combinations in which, for example, the network controller having a function of the network management router (60) or the server 1 (20) having a function of the network controller (10) may be connected to the access router 001 (40) and the center router A (30) through the network management router (60).

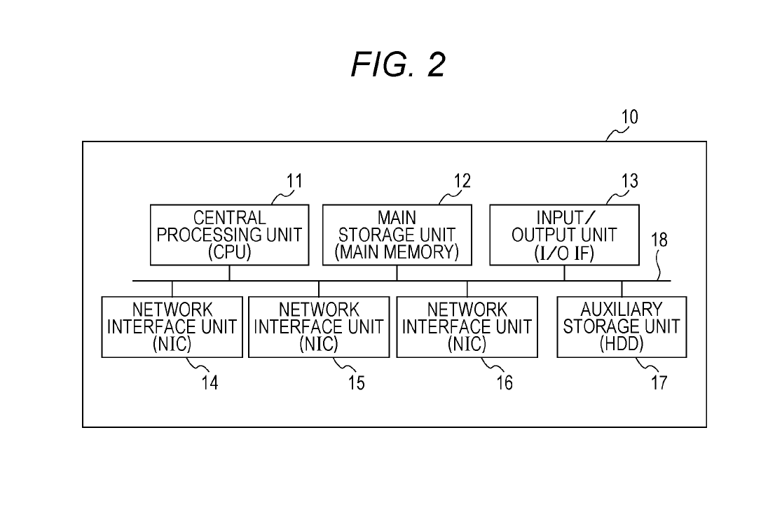

FIG. 2 is a diagram showing a hardware configuration of the network controller and the server of an embodiment of the present invention.

In FIG. 2, the network controller (10) and the server include a central processing unit (CPU) (11), a main storage unit (main memory) (12), an input/output unit (I/O IF) (13), network interface units (network interface card (NIC)) (14, 15, and 16), and an auxiliary storage unit (hard disk drive (HDD)) (17) which are connected to each other through an internal transmission path (18), such as a path. The network interface units (NIC) (14, 15, and 16) in the network controller (10) are connected to the HUB (70). On the other hand, the network interface units (NIC) (14, 15, and 16) in the server 1 (20) to the server 3 (22) are connected to the center router A (30), the center router B (31) and the HUBs (70, 71). Alternatively, the network interface unit (NIC) may be connected to other devices through a communication network, such as an IP router.

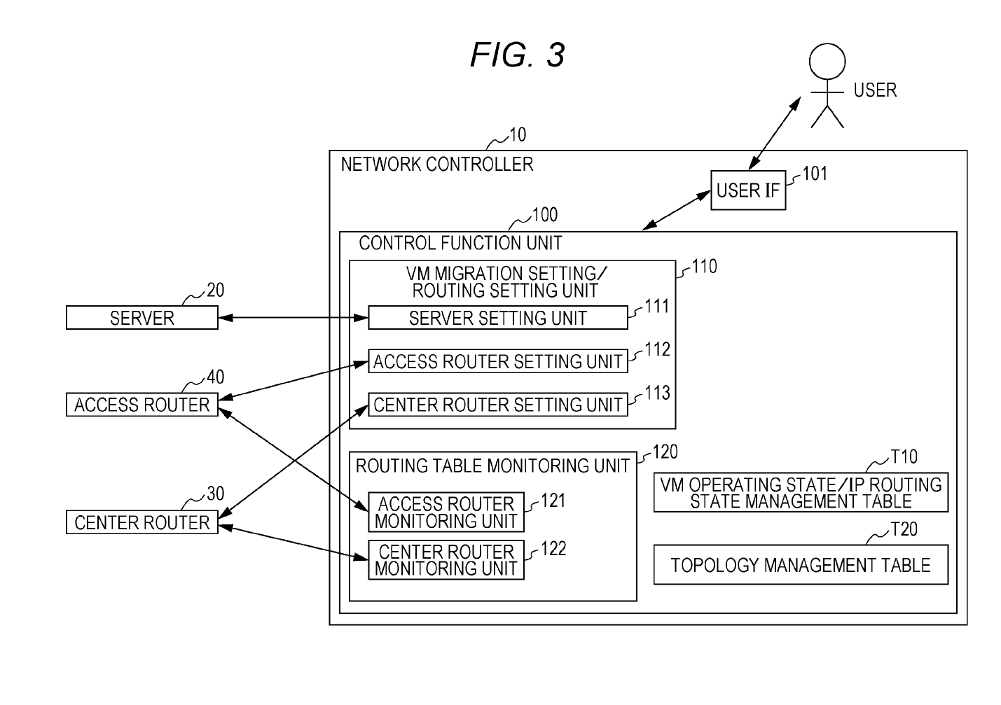

FIG. 3 is a diagram showing a software configuration of the network controller of an embodiment of the present invention.

In FIG. 3, the network controller (10) includes a user IF (101) which receives operations of a user and a control function unit (100).

The control function unit (100) includes a VM migration setting/routing setting unit (110), a routing table monitoring unit (120), a VM operating state/IP routing state management table (T10), and a topology management table (T20). The VM migration setting/routing setting unit (110) includes a server setting unit (111), an access router setting unit (112), and a center router setting unit (113).

The server setting unit (111) of the VM migration setting/routing setting unit (110) sets routing information of the server (20). The access router setting unit (112) sets routing information of the access router (40). The center router setting unit (113) sets routing information of the center router (30).

The routing table monitoring unit (120) includes an access router monitoring unit (121) and a center router monitoring unit (122). The access router monitoring unit (121) acquires the routing information of the access router (40). The center router monitoring unit (122) acquires the routing information of the center router (30).

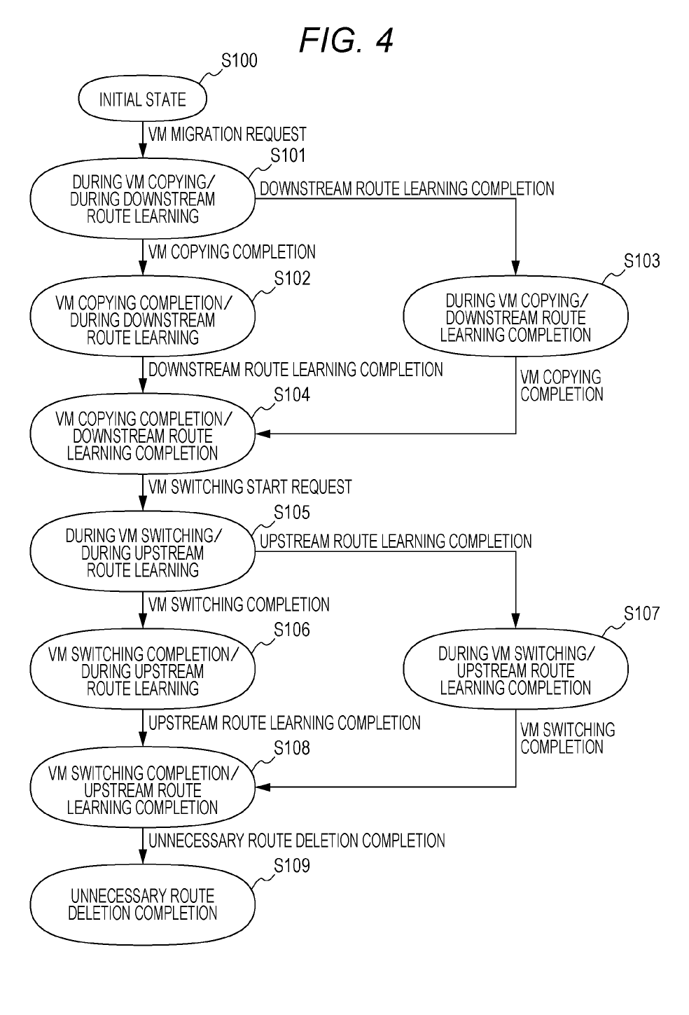

FIG. 4 is a diagram showing state transition of the network controller of an embodiment of the present invention.

In FIG. 4, the network controller receives a VM migration request event in an initial state (S100) and changes a state during VM copying/during downstream route learning (S101). When a VM copying completion event is received in the state during VM copying/during downstream route learning (S101), the state is changed to a state in VM copying completion/during downstream route learning (S102). When a downstream route learning completion event is received in the state during VM copying/during downstream route learning (S101), the state is changed to a state during VM copying/downstream route learning completion (S103).

When the downstream route learning completion event is received in the state in VM copying completion/during downstream route learning (S102) and the VM copying completion event is received in the state during VM copying/downstream route learning completion (S103), the network controller changes a state in VM copying completion/downstream route learning completion (S104). When a VM switching start request event is received in the state in VM copying completion/downstream route learning completion (S104), the state is changed to a state during VM switching/during upstream route learning (S105).

When a VM switching completion event is received in the state during VM switching/during upstream route learning (S105), the state is changed to a state in VM switching completion/during upstream route learning (S106). When an upstream route learning completion event is received in the state during VM switching/during upstream route learning (S105), the state is changed to a state during VM switching/upstream route learning completion (S107). When the upstream route learning completion event is received in the state in VM switching completion/during upstream route learning (S106) and the VM switching completion event is received in the state during VM switching/upstream route learning completion (S107), the state is changed to a state in VM switching completion/upstream route learning completion (S108).

When an unnecessary route deletion completion event is received in the state in VM switching completion/upstream route learning completion (S108), the state is changed to a state in unnecessary route deletion completion (S109).

Next, the contents of the processing of the embodiment shown as the state transition in FIG. 4 will be described with reference to the sequence diagram.

In the embodiment, an example in which a user requests to move the VMID001 (201) operating on the hypervisor (200) of the server 1 (20) to the hypervisor (210) on the server 2 (21) will be shown.

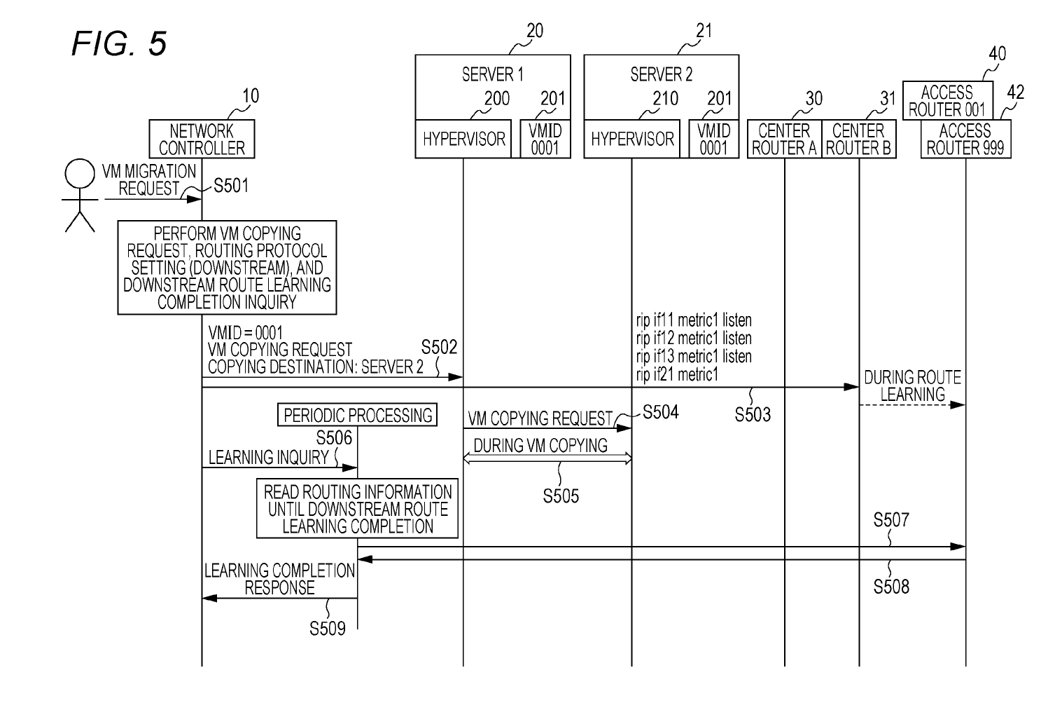

FIG. 5 is a sequence diagram showing the processing from a VM migration request to downstream route learning completion of an embodiment of the present invention.

In FIG. 5, when the network controller (10) receives the VM migration request from the user (S501), the network controller (10) requests a VM copying request (S502) and a routing protocol setting (downstream and a downstream route learning completion inquiry) from the hypervisor (200) of the server 1 (20) from which the VM is moved. Furthermore, the network controller (10) performs a routing configuration to the center router B (31) (S503).

The hypervisor (200) of the server 1 (20) receives the VM copying request from the network controller (10) and issues the VM copying request to the hypervisor (210) of the server 2 (21) (S504). After the VM copying request is issued, the VM copying is performed between the hypervisor (200) and the hypervisor (210) (S505). The network controller (10) performs a learning inquiry in periodic processing to the routing table monitoring unit (120) of the network controller (10) (S506) until a downstream route learning response is received. The routing table monitoring unit (120) reads the routing information of the access router 001 (40) to the access router 999 (42) (S507 and S508). When determining learning completion, the routing table monitoring unit (120) issues a learning completion response to the network controller (10) (S509).

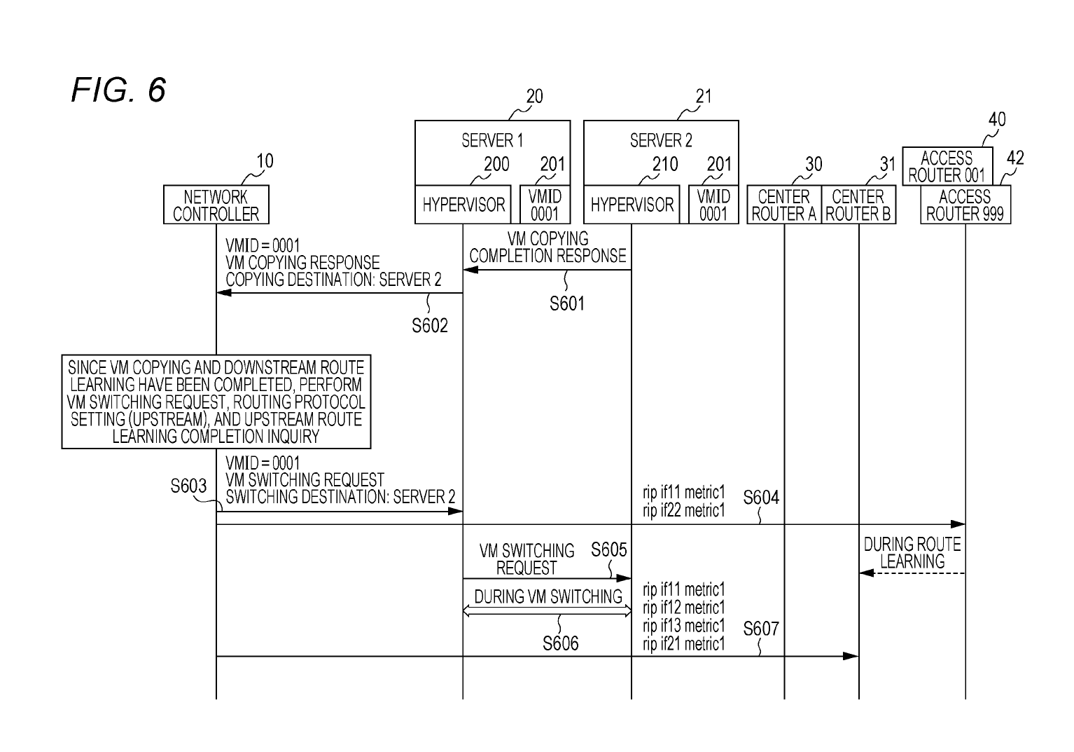

FIG. 6 is a sequence diagram showing the processing from a VM copying completion response to an upstream route learning start of an embodiment of the present invention.

In FIG. 6, the hypervisor (200) of the server 1 (20) receives a VM copying completion response from the hypervisor (210) of the server 2 (21) (S601). When receiving the VM copying completion response from the hypervisor (210) of the server 2 (21), the hypervisor (200) of the server 1 (20) notifies the network controller (10) of a VMID, a VM copying response, and a copying destination, (S602). When receiving the VMID, the VM copying response, and the copying destination, the network controller (10) determines the VM copying completion and the downstream route learning completion, performs a VM switching request, a routing protocol setting (upstream), and an upstream route learning completion inquiry and issues the VM switching request to the hypervisor (200) of the server 1 (20) (S603). Then, the network controller (10) sets set values for upstream route learning to the access router 001 (40) to the access router 999 (42) and the center router B (31) (S604 and S607). When receiving the VM switching request, the hypervisor (200) of the server 1 (20) issues the VM switching request to the hypervisor (210) of the server 2 (21) (S605). After the VM switching request is issued, the VM switching is performed between the hypervisor (200) and the hypervisor (210) (S606).

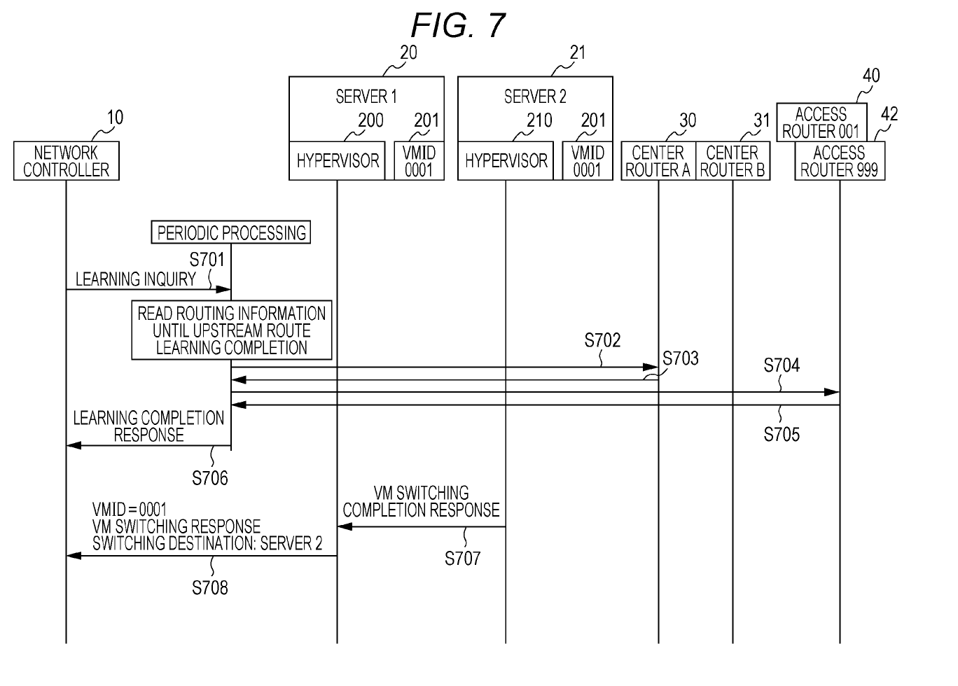

FIG. 7 is a sequence diagram showing the processing from upstream route learning completion waiting to a VM switching completion response of an embodiment of the present invention.

In FIG. 7, the network controller (10) performs a learning inquiry in periodic processing to the routing table monitoring unit (120) of the network controller (10) (S701). The routing table monitoring unit (120) reads the routing information of the center router B (31) and the access router 001 (40) to the access router 999 (42) until the upstream route learning response is received (S702 to S705). When determining the learning completion, the routing table monitoring unit (120) issues the learning completion response to the network controller (10) (S706). Furthermore, when determining the VM switching completion, the hypervisor (210) of the server 2 (21) (S707) issues the VM switching completion response to the hypervisor (200) of the server 1 (20). When receiving the VM switching completion response, the hypervisor (200) of the server 1 (20) issues a VM switching response to the network controller (10) (S708).

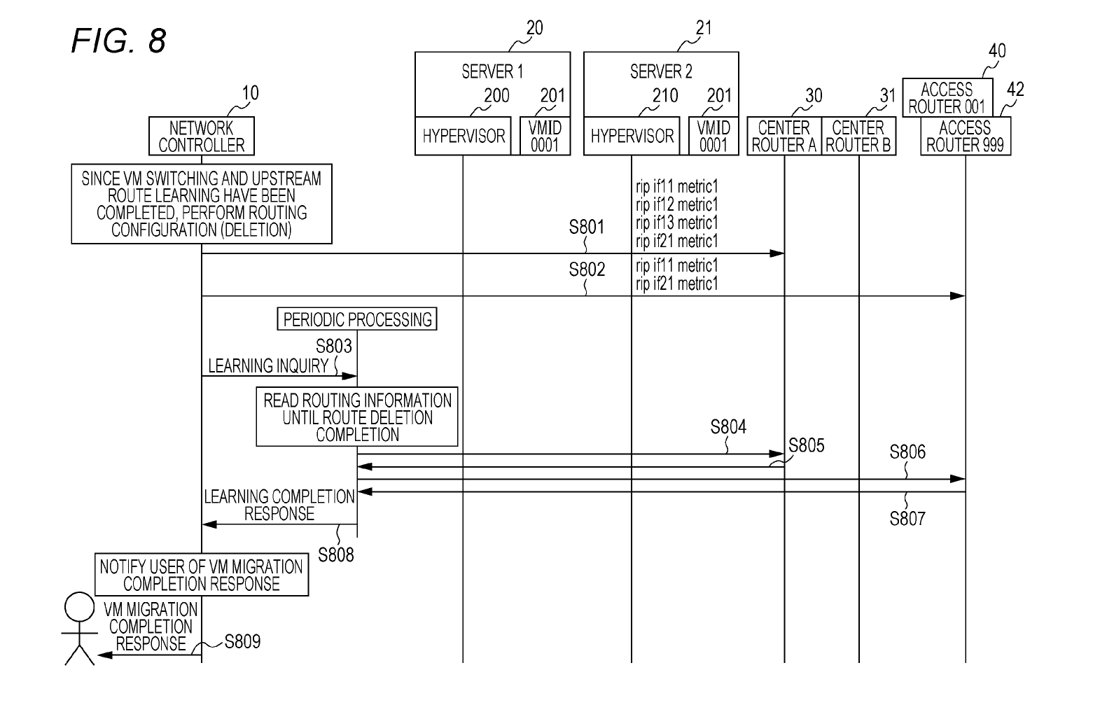

FIG. 8 is a sequence diagram showing the processing from an unnecessary route deletion request to a VM migration completion response of an embodiment of the present invention.

In FIG. 8, the network controller (10) determines the VM switching and the upstream route learning completion and performs a routing configuration (deletion). The network controller (10) sets the set values for the routing configuration (deletion) to the center router A (30) and the access router 001 (40) to the access router 999 (42) (S801 and S802). The routing table monitoring unit (120) of the network controller (10) reads the routing information of the center router A (30) and the access router 001 (40) to the access router 999 (42) in periodic processing (S804 to S807), determines the route deletion completion, and issues the learning completion response to the network controller (10) (S808). When receiving the VM migration completion response from the routing table monitoring unit (120), the network controller (10) notifies the user of the VM migration completion (S809).

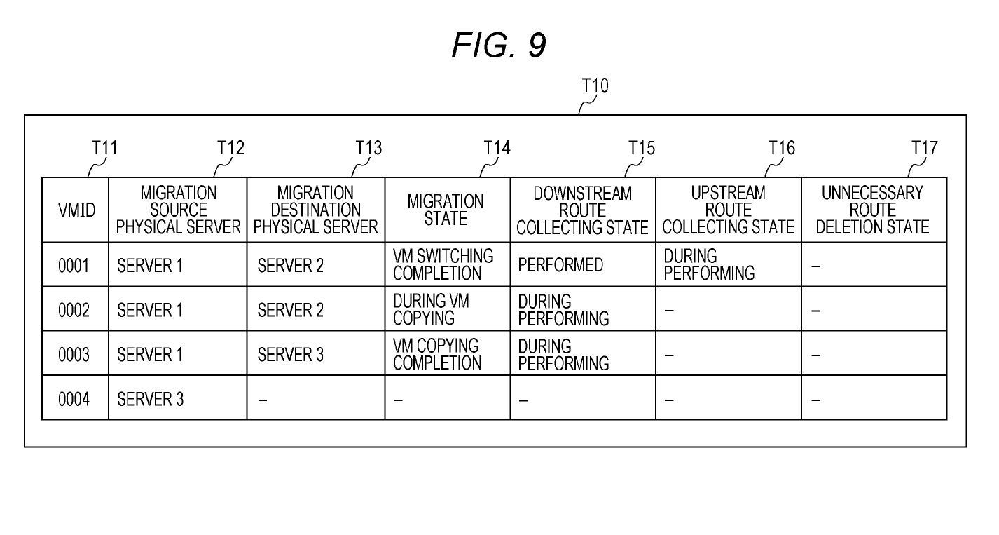

FIG. 9 is a diagram showing a configuration example of a VM operating state/IP routing state management table held by the network controller.

The VM operating state/IP routing state management table (T10) shown in FIG. 9 is held by the network controller (10). The VM operating state/IP routing state management table (T10) manages the VM migration state and the routing state of the network controller described in the diagram of the state transition of FIG. 4 when the VM migration request from the user is received. The VM operating state/IP routing state management table (T10) holds information of a VMID (T11), a migration source physical server (T12), a migration destination physical server (T13), a migration state (T14), a downstream route collecting state (T15), an upstream route collecting state (T16), and an unnecessary route deletion state (T17). In the VMID (T10), existing VMIDs are listed in the vertical line. In the migration source physical server (T12), migration source physical servers are listed. In the migration destination physical server (T13), migration destination physical servers designated by the user are listed. In the migration state (T14), the states (during VM copying, VM copying completion, during VM switching, VM switching completion) determined by the network controller (10) are listed. In the downstream route collecting state (T15), the upstream route collecting state (T16), and the unnecessary route deletion state (T17), the processing states, (not performed, during performing, performed) determined by the network controller (10), of downstream route collecting processing, upstream route collecting processing, and unnecessary route deletion processing are listed. Furthermore, hyphens (-) indicate the state that the processing of the migration source physical server (T12), the migration destination physical server (T13), the migration state (T14), the downstream route collecting state (T15), the upstream route collecting state (T16), and the unnecessary route deletion state (T17) is not started.

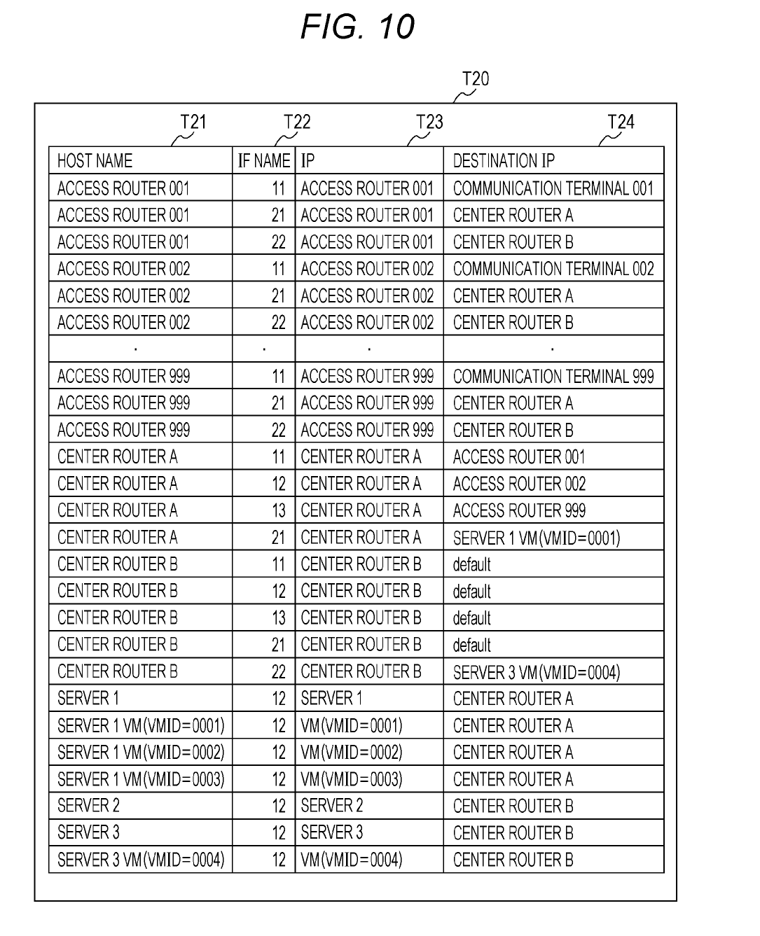

FIG. 10 is a diagram showing a configuration example of a topology management table held by the network controller.

In FIG. 10, a topology management table (T20) is reflected and holds the routing information of the access router and the center router which is periodically obtained by the access router monitoring unit (121) and the center router monitoring unit (122) of the routing table monitoring unit (120) of the network controller (10). That is, the topology management table (T20) manages the routing information, such as the access router, the center router, the server, the VM which are connected to the network controlled by the network controller (10), and holds information of a host name (T21), an IF name (T22), an IP (T23), and a destination IP (T24). In the host name (T21), host names are listed. In the IF name (T22), IF names to be connected are listed. In the IP (T23), the IPs assigned to the IF names (T22) are listed. In the destination IP (T24), the destination IPs of the IF names (T22) are listed.

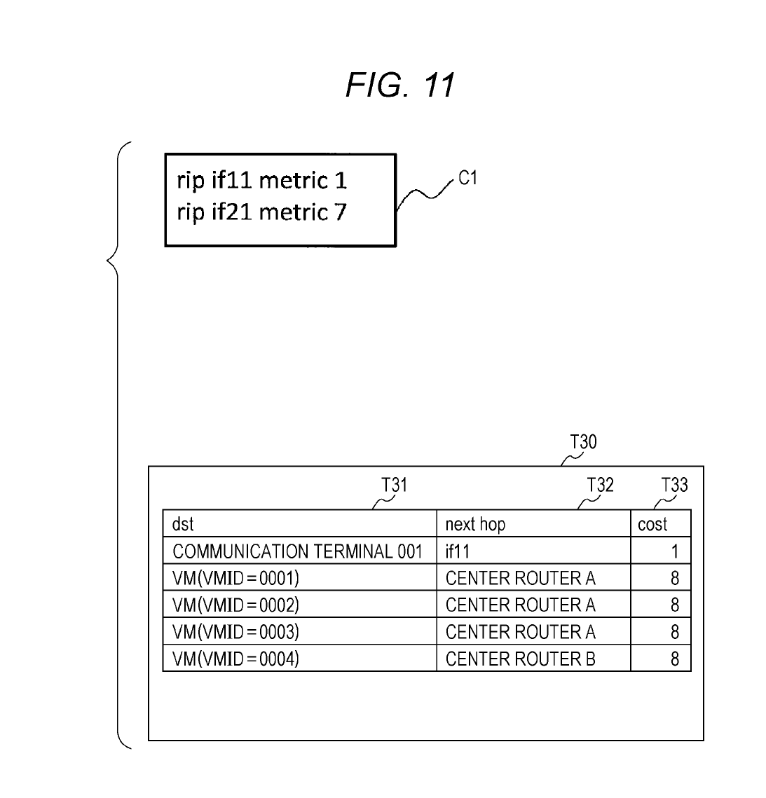

FIG. 11 is a diagram showing an example of the setting information and the routing table held by the access router 001 in the initial state.

As shown in FIG. 11, the set values (C1) of the setting information held by the access router 001 (40) are configured with a protocol to be used, a destination, and a distance. As an example of the set values held in the initial state in FIG. 11, it is assumed that the protocol to be used is rip, the destination is if11, the destination is metric 1, the protocol to be used is rip, the destination is if21, and the distance is metric 7.

A routing table (T30) holds the information of a dst (T31), a next hop (T32), and a cost (T33). In the dst (T31), the destination networks are listed. In the next hop (T32), in order to transfer the received packet to the destination network, addresses of adjacent routers to which the packet is transferred next are listed. The cost (T33) is used to select an optimum route. In the embodiment, since a routing information protocol (RIP) is used, cost values are listed in the cost (T33). The routing table held by the access router 001 (40) in the initial state stores, for example as shown in FIG. 11, the next hops, and the cost values with respect to the communication terminal 001 and the VMID0001 to the VMID0004 in the destination network.

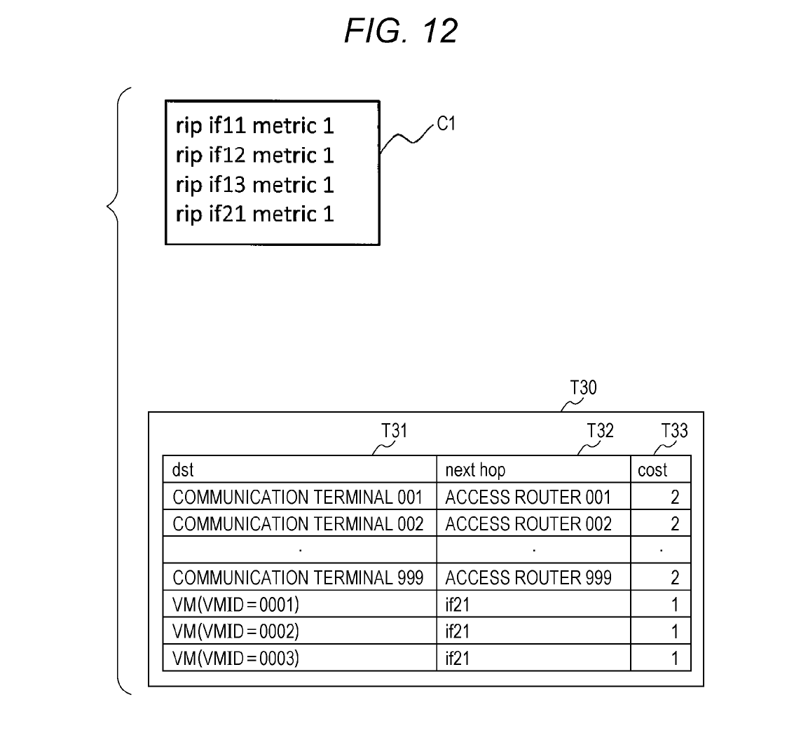

FIG. 12 is a diagram showing an example of the setting information and the routing table held by the center router A in an initial state.

As the set values in the initial state of the embodiment shown in FIG. 12, the center router A (30) holds “rip if11 metric 1”, “rip if12 metric 1”, “rip if13 metric 1”, and “rip if21 metric 1”. Furthermore, in the routing table, the next hops and the cost values are set with respect to the communication terminal 001 to the communication terminal 999 and the VMID0001 to VMID0003 in the destination network.

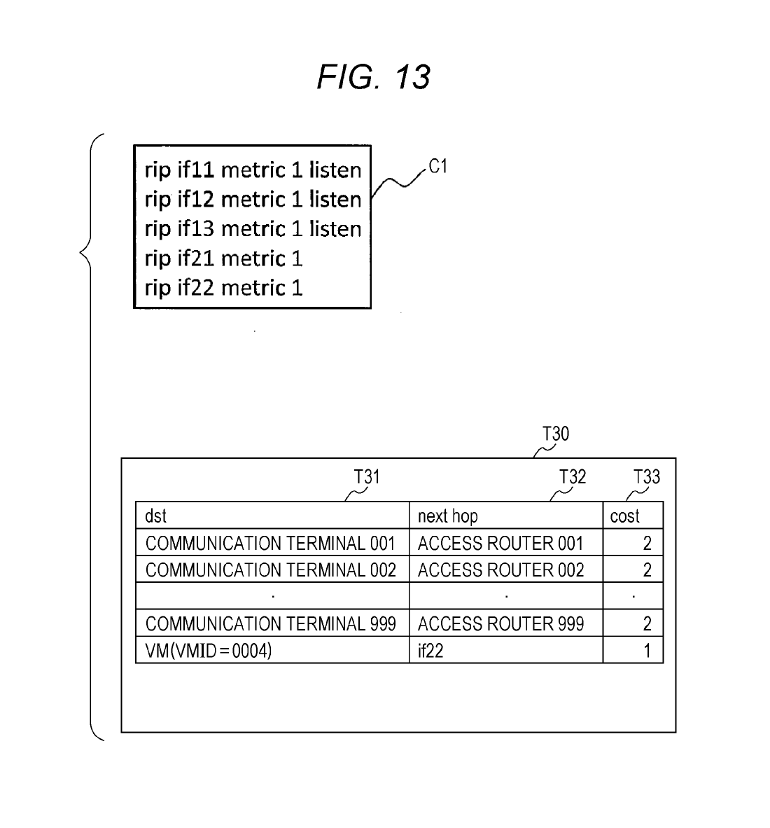

FIG. 13 is a diagram showing an example of the setting information held by the center router B at downstream route learning and an example of the routing table of the center router B after downstream route learning.

In FIG. 13, in the set value (C1) of the setting information held by the center router B (31), “listen” is provided with the set value of the downstream direction and it is assumed that the downstream route learning can be performed but data cannot be received. In the routing table of the center router B after downstream route learning, the next hops, and the cost values are set with respect to the communication terminal 001 to the communication terminal 999 and the VMID0004 in the destination network.

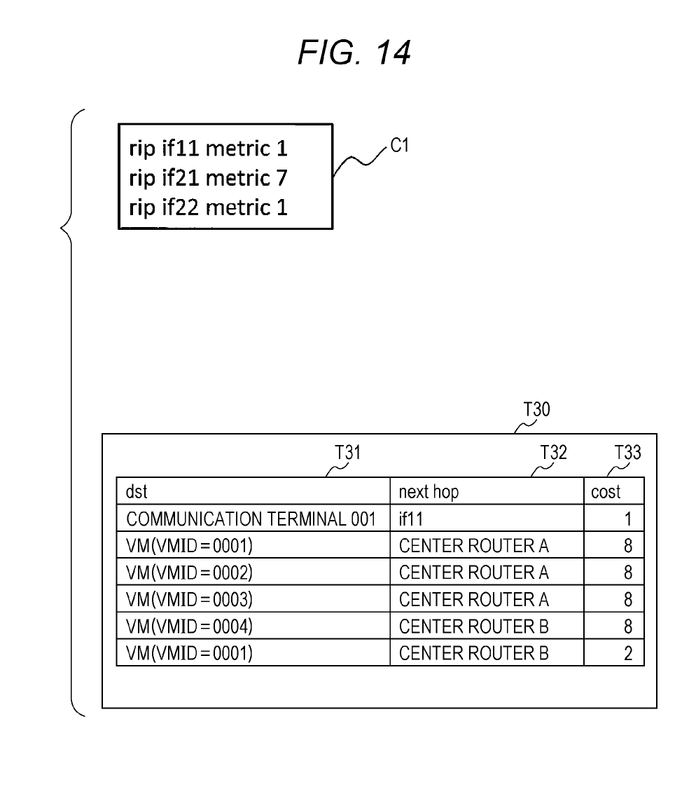

FIG. 14 is a diagram showing an example of the setting information held by the access router 001 at upstream route learning and an example of the routing table of the access router 001 after upstream route learning.

As shown in FIG. 14, as the set value (Cl) of the setting information at upstream route learning in the embodiment, the access router 001 holds “rip if11 metric 1”, “rip if21 metric 7”, and “rip if22 metric 1”. Furthermore, in the routing table of the access router 001 at upstream route learning, the routing information is set with respect to the communication terminal 001 in the destination network, to the center router A in the next hop and the VMID0001 to the VMID0003 in the destination network, and to the center router B in the next hop and the VMID0004 and the VMID0001 in the destination network.

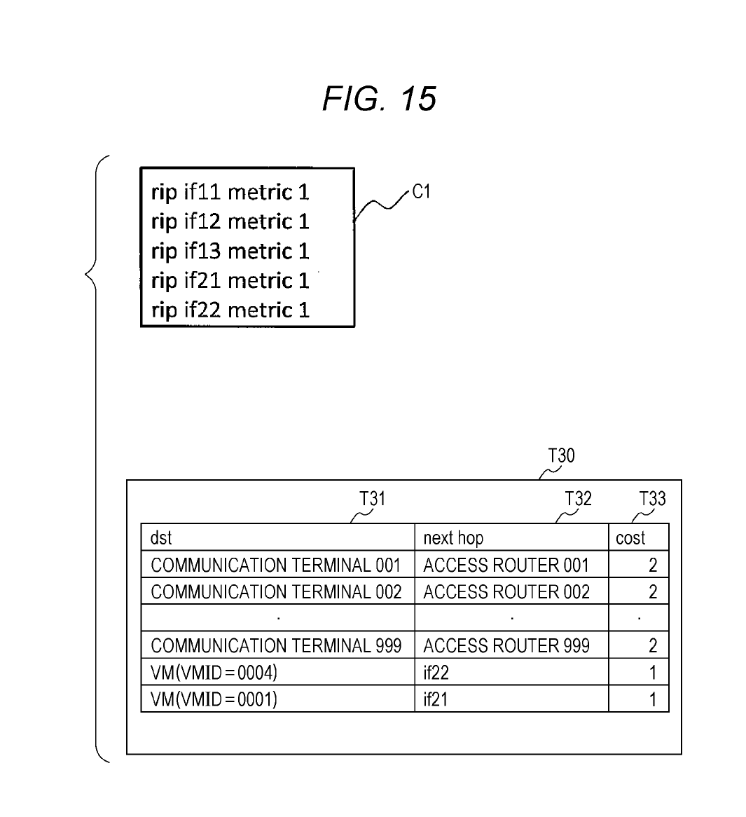

FIG. 15 is a diagram showing an example of the setting information held by the center router B at upstream route learning and an example of the routing table of the center router B after upstream route learning.

In FIG. 15, as the set values of the setting information held by the center router B (31), the embodiment holds “rip if11 metric 1”, “rip if12 metric 1”, “rip if13 metric 1”, “rip if21 metric 1”, and “rip if22 metric 1”. In the routing table of the center router B after the upstream route learning in the embodiment, the next hops and the cost values are set with respect to the communication terminal 001 to the communication terminal 999, the VMID0001, and the VMID0004 in the destination network.

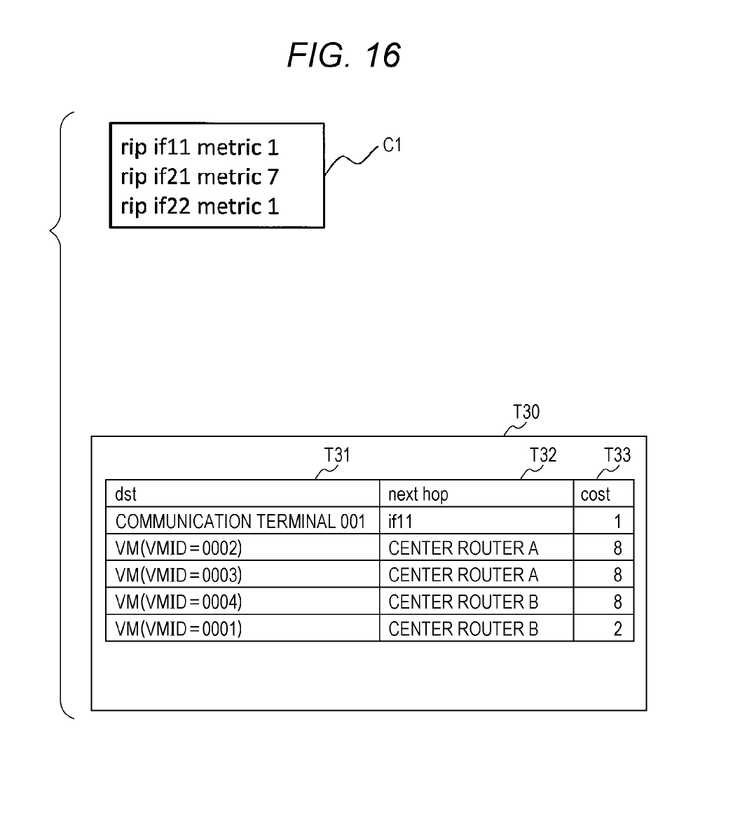

FIG. 16 is a diagram showing an example of the setting information held by the access router 001 at unnecessary route deletion and an example of the routing table of the access router 001 after unnecessary route deletion.

In FIG. 16, as the set values of the setting information held by the access router 001, the embodiment holds “rip if11 metric 1”, “rip if21 metric 7”, and “rip if22 metric 1”. In the routing table of the access router 001 after the upstream unnecessary route deletion in the embodiment, the next hops and the cost values are set with respect to the communication terminal 001, the VMID0002 to the VMID0004, and the VMID0001 after migration in the destination network.

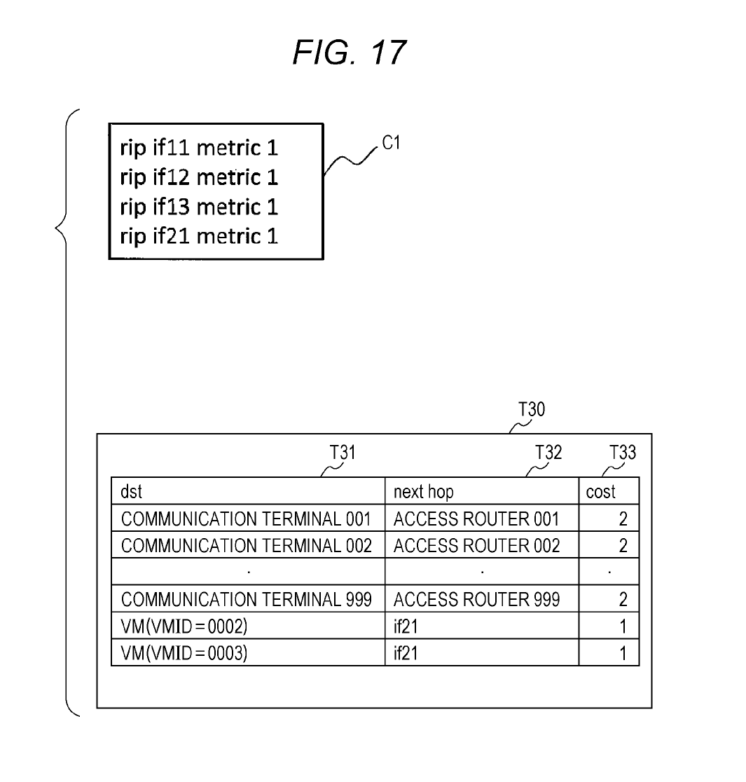

FIG. 17 is a diagram showing an example of the setting information held by the center router A at unnecessary route deletion and an example of the routing table of the center router A after unnecessary route deletion.

In FIG. 17, as the set values of the setting information held by the center router A, the embodiment holds “rip if11 metric 1”, “rip if12 metric 1”, “rip if13 metric 1”, and “rip if21 metric 1”. In the routing table of the center router A after the unnecessary route deletion, the next hops and the cost values are set with respect to the communication terminal 001 to the communication terminal 999, the VMID0002, and the VMID0003 in the destination network.

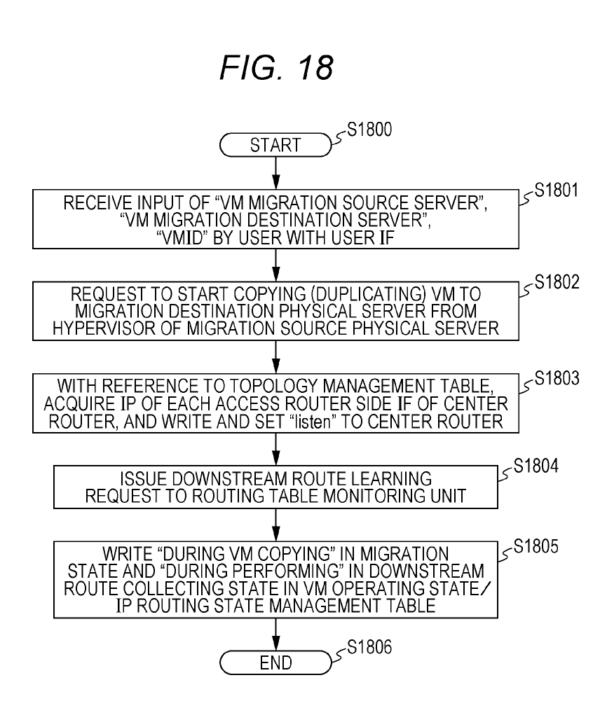

With reference to FIG. 18, the flow of the network controller when the VM migration start request event is received form the initial state will be described.

The network controller (10) receives the input of “VM migration source server”, “VM migration destination server”, and “VMID” by the user with the user IF (101) (S1801). The VM migration setting/routing setting unit (110) of the network controller (10) requests to start copying (duplicating) VM to the migration destination physical server (T13) from the hypervisor of the migration source physical server (T12) (S1802). The VM migration setting/routing setting unit (110) acquires, with reference to the topology management table (T20), the IP of each access router side IF of the center router, and writes and sets “listen” to the center router (S1803). The VM migration setting/routing setting unit (110) issues the downstream route learning request to the routing table monitoring unit (120) (S1804). Furthermore, the VM migration setting/routing setting unit (110) writes “during VM copying” in the migration state (T14) and “during performing” in the downstream route collecting state (T15) in the VM operating state/IP routing state management table (T10) (S1805).

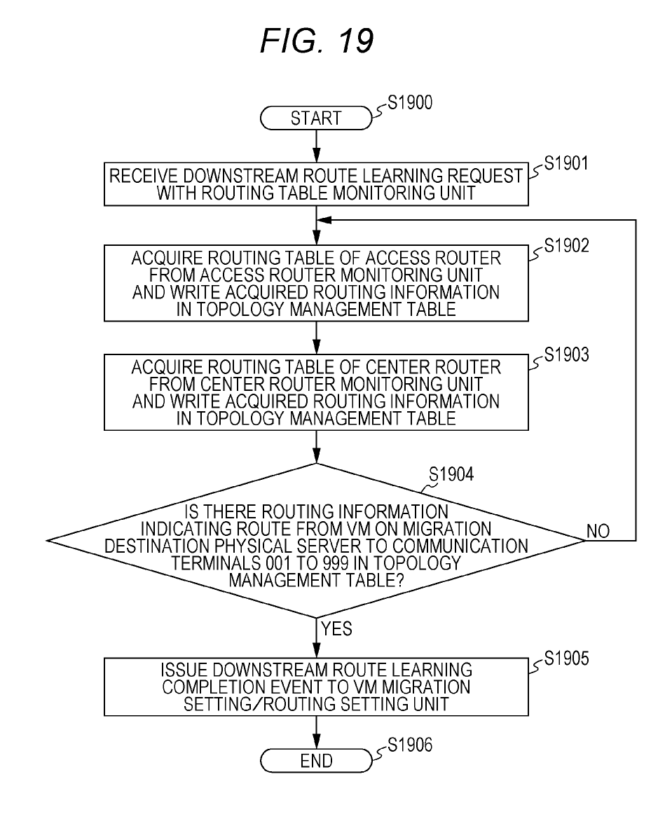

With reference to FIG. 19, the flow of downstream learning completion determination processing in the routing table monitoring unit of the network controller will be described.

The routing table monitoring unit (120) receives the downstream route learning request (S1901). The routing table monitoring unit (120) acquires the routing table of the access router from the access router monitoring unit (121) and writes the acquired routing information in the topology management table (T20) (S1902). The routing table monitoring unit (120) acquires the routing table of the center router from the center router monitoring unit (122) and writes the acquired routing information in the topology management table (T20) (S1903). The routing table monitoring unit (120) determines whether there is the routing information indicating a route from the VM on the migration destination physical server (T13) to the communication terminal 001 to the communication terminal 999 in the topology management table (T20) (S1904). When the information is in the topology management table (T20), the routing table monitoring unit (120) issues a downstream learning completion event to the VM migration setting/routing setting unit (S1905). When the routing information indicating a route from the VM on the migration destination physical server (T13) to the communication terminal 001 to the communication terminal 999 is not in the topology management table (T20), the routing table monitoring unit (120) executes step 1902.

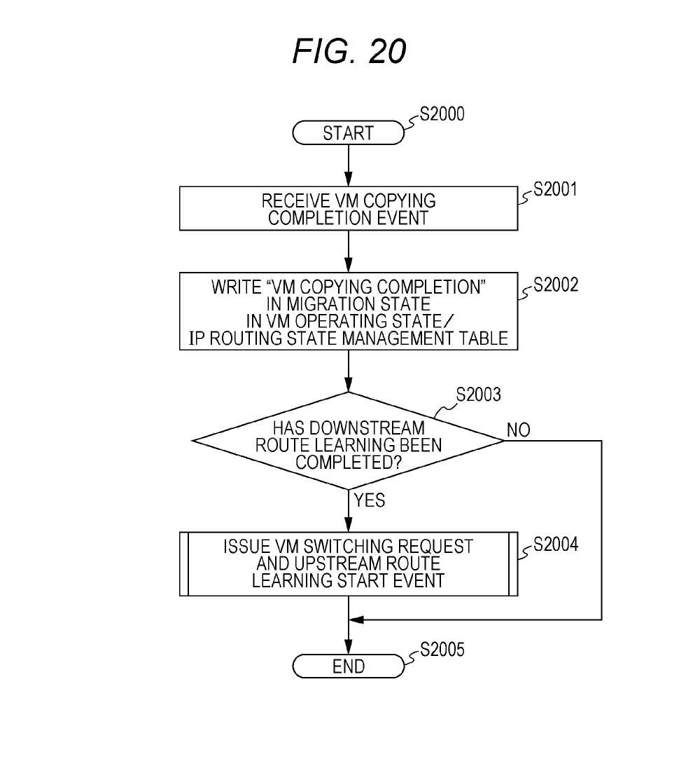

With reference to FIG. 20, the flow when the VM migration setting/routing setting unit of the network controller receives the VM copying completion event will be described.

The VM migration setting/routing setting unit (110) of the network controller (10) receives the VM copying completion event (S2001). The VM migration setting/routing setting unit (110) writes “VM copying completion” in the migration state (T14) in the VM operating state/IP routing state management table (T10) (S2002). The VM migration setting/routing setting unit (110) checks the downstream route collecting state (T15) in the VM operating state/IP routing state management table (T10) (S2003). When the state is “performed”, the VM migration setting/routing setting unit (110) issues the VM switching request and the upstream route learning start event (S2004). Upon checking the downstream route collecting state (T15), when the downstream route collecting state is “not performed” (indicated with a hyphen (-) in FIG. 9) or “during performing”, the processing is ended (S2005).

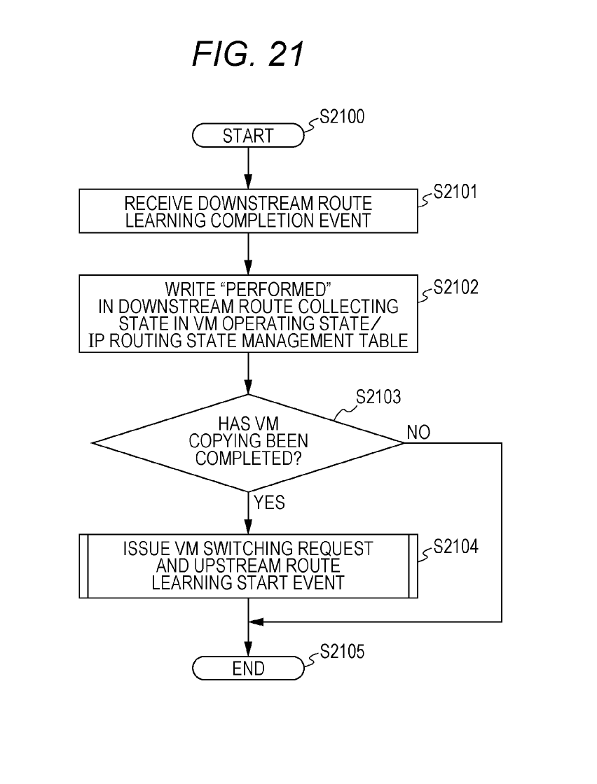

With reference to FIG. 21, the flow when the VM migration setting/routing setting unit of the network controller receives the downstream route learning completion event will be described.

The VM migration setting/routing setting unit (110) of the network controller (10) receives the downstream route learning completion event (S2101). The VM migration setting/routing setting unit (110) writes “performed” in the downstream route collecting state (T15) in the VM operating state/IP routing state management table (T10) (S2102). The VM migration setting/routing setting unit (110) checks the migration state (T14) in the VM operating state/IP routing state management table (T10) (S2103). When the state is “VM copying completion”, the VM migration setting/routing setting unit (110) issues the VM switching request and the upstream route learning start event (S2104). Upon checking the migration state (T14), when the VM copying is “not performed” (indicated with a hyphen (-) in FIG. 9), or “during VM copying”, the processing is ended (S2105).

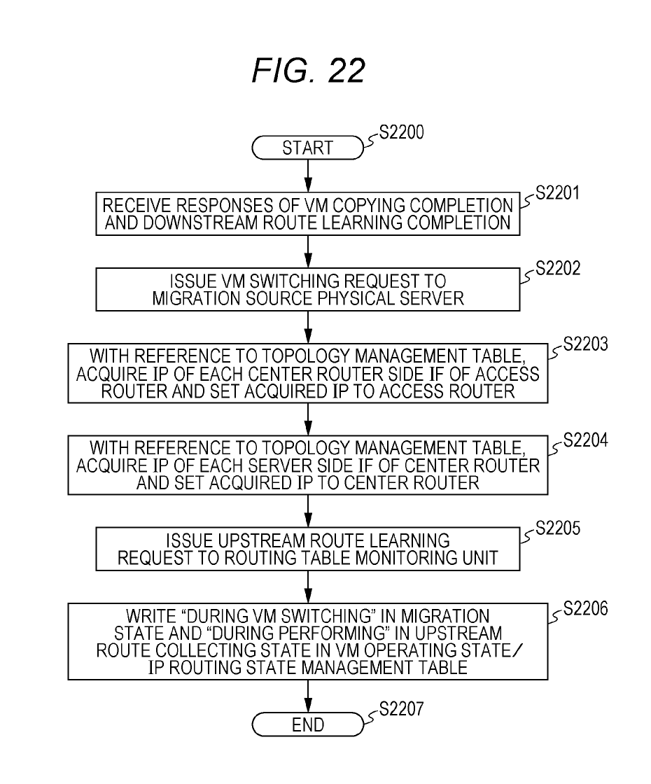

With reference to FIG. 22, the flow when the VM migration setting/routing setting unit of the network controller issues the VM switching request and the upstream route learning request will be described.

The VM migration setting/routing setting unit (110) of the network controller (10) receives responses of the VM copying completion and the downstream route learning completion (S2201). The VM migration setting/routing setting unit (110) issues the VM switching request to the migration source physical server (T12) (S2202). The VM migration setting/routing setting unit (110) acquires, with reference to the topology management table (T20), the IP of each center router side IF of the access router and sets the acquired IP to the access router (S2203). The VM migration setting/routing setting unit (110) acquires, with reference to the topology management table (T20), the IP of each server side IF of the center router and sets the acquired IP to the center router (S2204). The VM migration setting/routing setting unit (110) issues the upstream route learning request to the routing table monitoring unit (120) (S2205). The VM migration setting/routing setting unit (110) writes “during VM switching” in the migration state (T14) and “during performing” in the upstream route collecting state (T16) in the VM operating state/IP routing state management table (T10) (S2206).

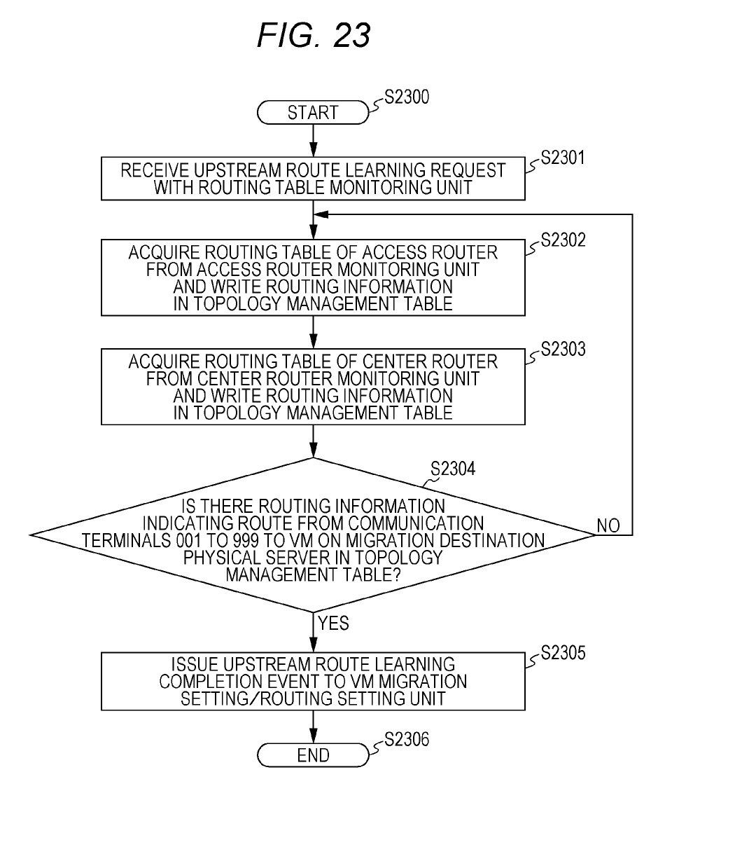

With reference to FIG. 23, the flow of the upstream route learning completion determination processing in the routing table monitoring unit of the network controller will be described.

The network controller (10) receives the upstream route learning request with the routing table monitoring unit (120) (S2301). The routing table monitoring unit (120) acquires the routing table of the access router from the access router monitoring unit (121) and writes the acquired routing information in the topology management table (T20) (S2302). The routing table monitoring unit (120) acquires the routing table of the center router from the center router monitoring unit (122) and writes the acquired information in the topology management table (T20) (S2303). The routing table monitoring unit (120) determines whether there is routing information indicating a route from the communication terminal 001 to the communication terminal 999 to the VM on the migration destination physical server (T13) in the topology management table (T20) (S2304). When the information is in the topology management table (T20), the routing table monitoring unit (120) issues the upstream route learning completion event to the VM migration setting/routing setting unit (110) (S2305). When the routing information indicating a route from the communication terminal 001 to the communication terminal 999 to the VM on the migration destination physical server (T13) is not in the topology management table (T20), the routing table monitoring unit (120) executes step 2302.

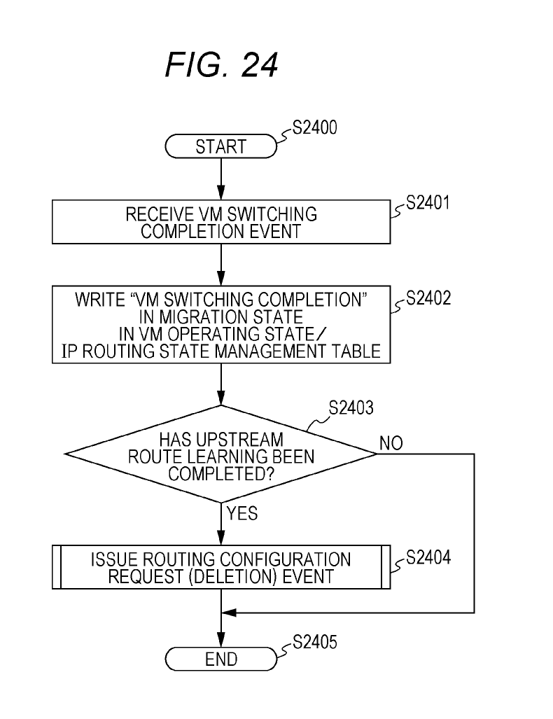

With reference to FIG. 24, the flow when the VM migration setting/routing setting unit of the network controller receives the VM switching completion event will be described.

The VM migration setting/routing setting unit (110) of the network controller (10) receives the VM switching completion event (S2401). The VM migration setting/routing setting unit (110) writes “VM switching completion” in the migration state (T14) in the VM operating state/IP routing state management table (T10) (S2402). The VM migration setting/routing setting unit (110) checks the upstream route collecting state (T16) in the VM operating state/IP routing state management table (T10) (S2403). When the state is “performed”, the VM migration setting/routing setting unit (110) issues a routing configuration request (deletion) event (S2404). Upon checking the upstream route collecting state (T16) (S2403), when the upstream route collecting is “not performed” (indicated with a hyphen (-) in FIG. 9) or “during performing”, the processing is ended (S2405).

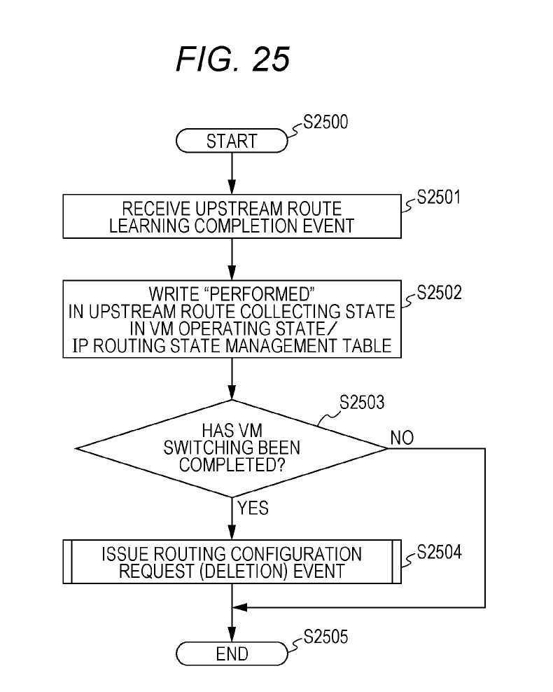

With reference to FIG. 25, the flow when the VM migration setting/routing setting unit of the network controller receives the upstream route learning completion event will be described.

The VM migration setting/routing setting unit (110) of the network controller (10) receives the upstream route learning completion event (S2501). The VM migration setting/routing setting unit (110) writes “performed” in the upstream route collecting state (T16) in the VM operating state/IP routing state management table (T10) (S2502). The VM migration setting/routing setting unit (110) checks the migration state (T14) in the VM operating state/IP routing state management table (T10) (S2503). When the state is “VM switching completion”, the VM migration setting/routing setting unit (110) issues the routing configuration request (deletion) event (S2504). Upon checking the migration state (T14) (S2503), when the VM copying is “not performed” (indicated with a hyphen (-) in FIG. 9) or “during VM switching”, the processing is ended (S2505).

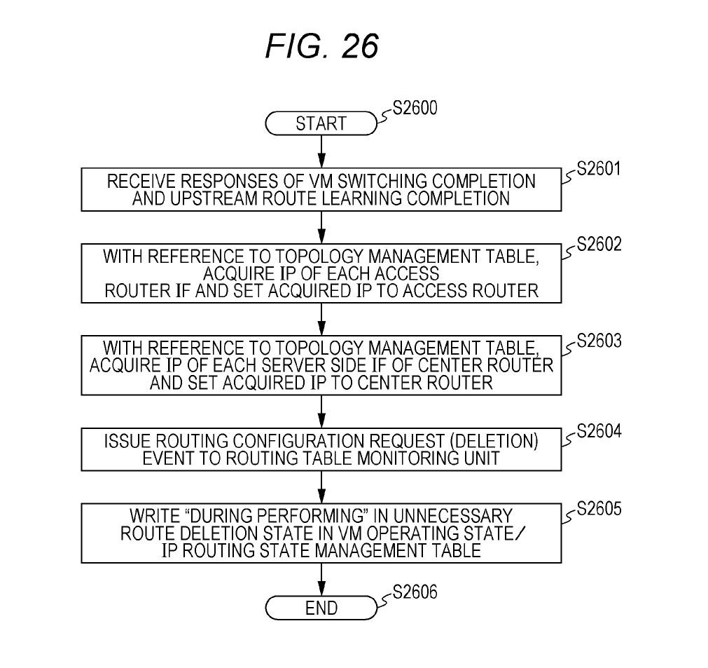

With reference to FIG. 26, the flow when the VM migration setting/routing setting unit of the network controller receives the unnecessary route deletion request will be described.

The VM migration setting/routing setting unit (110) of the network controller (10) receives responses of the VM switching completion and the upstream route learning completion (S2601). The VM migration setting/routing setting unit (110) acquires, with reference to the topology management table (T20), the IP of each IF of the access router and sets the acquired IP to the access router (S2602). The VM migration setting/routing setting unit (110) acquires, with reference to the topology management table (T20), the IP of each server side IF of the center router and sets the acquired IP to the center router (S2603). The VM migration setting/routing setting unit (110) issues the routing configuration request (deletion) event to the routing table monitoring unit (120) (S2604). The VM migration setting/routing setting unit (110) writes “during performing” in the unnecessary route deletion state (T17) in the VM operating state/IP routing state management table (T10) (S2605).

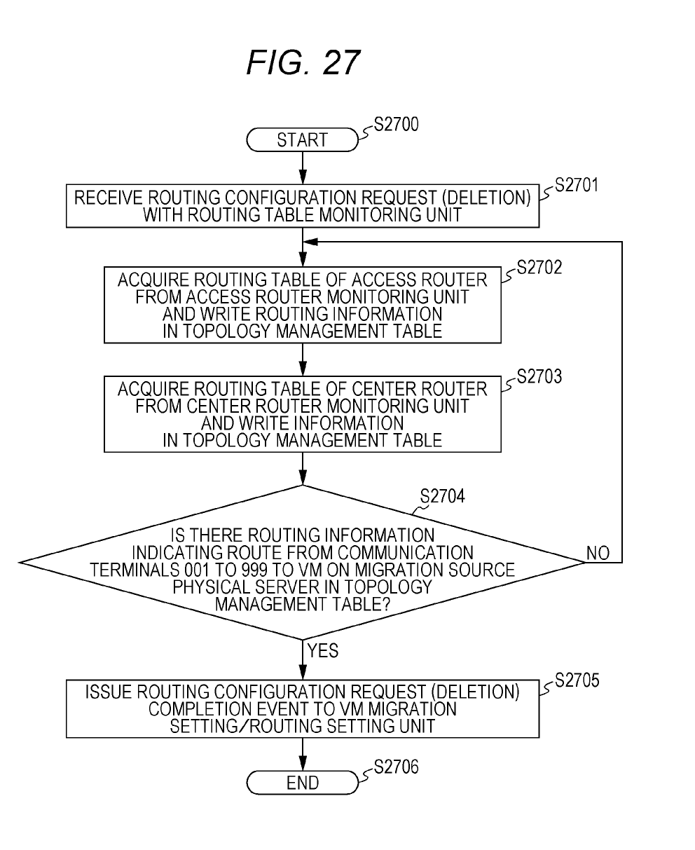

With reference to FIG. 27, the flow of the routing configuration request (deletion) completion determination processing in the routing table monitoring unit of the network controller will be described.

The network controller (10) receives the routing configuration request (deletion) with the routing table monitoring unit (120) (S2701). The routing table monitoring unit (120) acquires the routing table of the access router from the access router monitoring unit (121) and writes the acquired routing information in the topology management table (S2702). The routing table monitoring unit (120) acquires the routing table of the center router from the center router monitoring unit (122) and writes the acquired routing information in the topology management table (S2703). The routing table monitoring unit (120) determines that there is no routing information indicating a route from the communication terminal 001 to the communication terminal 999 to the VM on the migration source physical server (T12) in the topology management table (T20) (S2704). When the information is not in the topology management table (T20), the routing table monitoring unit (120) issues a routing configuration request (deletion) completion event to the VM migration setting/routing setting unit (110) (S2705). When the routing information indicating a route from the communication terminal 001 to the communication terminal 999 to the VM on the migration source physical server (T12) is in the topology management table (T20), the routing table monitoring unit (120) executes step 2702.

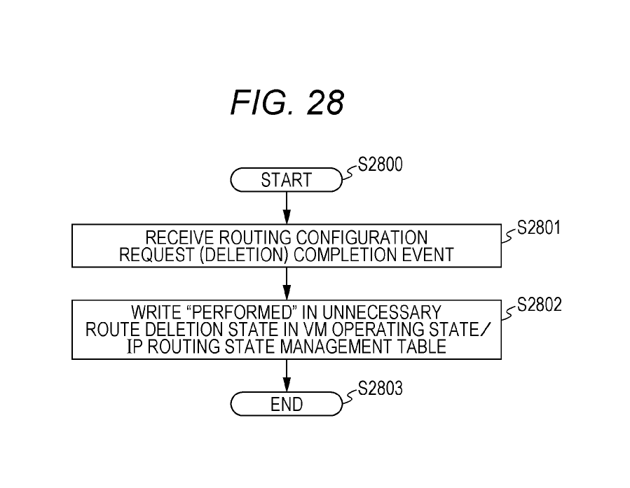

With reference to FIG. 28, the flow when the VM migration setting/routing setting unit of the network controller receives the routing configuration request (deletion) completion event will be described.

The VM migration setting/routing setting unit (110) of the network controller (10) receives the routing configuration request (deletion) completion event (S2801). The VM migration setting/routing setting unit (110) writes “performed” in the unnecessary route deletion state (T17) in the VM operating state/IP routing state management table (T10) (S2802).

In the embodiments, by primarily learning and setting the downstream route, learning the upstream route thereafter, and simultaneously transmitting/receiving the upstream route based on the setting of the network controller (10), a series of controls which enables to perform the route switching in a very short time has been described as an example. However, in the series of controls of the present invention, a certain communication direction, such as an upstream or a downstream, is unconcerned. When the direction is set, a route (the downstream route in the embodiments) which does not directly affect the existing communication (connected or communicating) is primarily controlled. Then, when a route actually needs to be changed (when the VM migration is started in the embodiments), the route which affects the existing communication (the upstream route in the embodiments) is controlled, which is the essential to solve the problems.

Furthermore, as a method for controlling a route, by using the method for propagating a route or information to determine a route (link state and the like) with a broadcast mechanism (for example, a broadcast, a multicast, route flooding, a route advertisement, link state flooding, a broadcast of configuration change message), the route switching time can be further shorten.

In the embodiments, as a method for learning a route, the routing information protocol (RIP) which is one of dynamic routing protocol is used, but other protocols, such as an open shortest path first (OSPF) and a border gateway protocol (BGP), may be used. When the OSPF is used as the method for learning a route, to independently control the timing of learning an upstream route and a downstream route, a link state may be controlled by one direction at a time. Furthermore, as other methods to use the OSPF, when it is assumed that a route between the center router and the server is out of the OSPF domain, the link state in the OSPF domain is primarily learned. Then, when the route actually needs to be changed (when the VM migration is started in the embodiments), the setting to learn the route out of the OSPF domain as the route out of domain may be performed.

Furthermore, the static route is not limited to a dynamic routing protocol, such as a routing information protocol (RIP) and may be set by a management/control protocol (simple network management protocol (SNMP), a NetConf, a command line interface (CLI), a simple object access protocol (SOAP), a representational state transfer (REST), an OpenFlow, and the like). In this case, it is preferable that a lower layer of the above management/control protocol or a broadcast mechanism to broadcast the management/control protocol is provided as a broadcast mechanism to control a route. For example, it is preferable that an IP multicast or an IEEE802.3 broadcast is used to broadcast a SNMP-SET or an OpenFlow message. Furthermore, a mechanism (application layer gateway) to interpret a message of a NetConf, a CLI, and the like and to broadcast the message to a plurality of routers may be provided.

In the embodiments, the example of copying the VMID001 (201) on the server 1 (20) to the server 2 (21) has been described. However, the number of copying source VMs is not limited to one and it is possible to copy a plurality of VMs in parallel.

In the embodiments, the example of copying the VM and performing route switching has been described. However, the present invention is applied to not only copying VM but also general route switching which is performed when an address communicating with a number of communication partners is changed. For example, the present invention is applicable to various cases in which, for example, an existing network routing is handed over to a newly constructed physical server.

In the embodiments, the example of learning an internet protocol (IP) transfer route in the network routed by an IP address when the IP address is changed in the network has been described. However, the address system and the transfer route learning/determining mechanism is not limited to this. The present invention is applicable to a general network which controls a communication route by propagating a route or a message to determine a route with a broadcast mechanism (a broadcast, a multicast, route flooding, a route advertising, link state flooding, a broadcast of configuration change message, and the, like). For example, the present application is applicable to a IEEE802.3 network, a multi protocol label switching (MPLS) network using a label distribution protocol (LDP), a metro ether forum (MEF) e-tree network, a content delivery network (CDN) and the like. When the present invention is applied to an IEEE802.3 network, it is preferable that a transfer route is controlled by an arbitrary frame, an address resolution protocol (ARP), a neighbor discovery protocol (NDP), or the like. Furthermore, the present invention is applicable to a network which has a multicast mechanism, is a transmission path of a point-to-multipoint, and has a mechanism for batch operation of a protection switch of a leaf node according to a broadcast of an operation administration and maintenance (OAM) frame from a root node.

In the embodiments, the example of copying and performing route switching by the network controller (10) upon receiving the request of the user has been described. However, the server 1 (20) and the like may have a plurality of triggers for copying. It is thereby possible to perform copying and route switching based on the timing managed by a scheduler.

What is claimed is:

1. A routing control method in a network in which a plurality of communication terminals and at least one server are connected through at least one router, the method comprising:
receiving, by a network controller, an event which changes a destination address of the at least one server, the network controller being configured to control the network and having routing information of the at least one router in the network and a function to control the routing information of the at least one router in the network;
in response to receiving the event, primarily controlling, by the network controller, routing information which does not affect a communication being connected; and
after processing of changing the destination address has been completed, controlling, by the network controller, routing information which affects the communication being connected.

2. The routing control method according to claim 1, wherein the routing information is controlled by using a broadcast mechanism.

3. The routing control method according to claim 1, wherein a destination of the plurality of communication terminals is a virtual machine on a server and the event which changes the destination address is accompanied by moving the virtual machine on the server to another server or by newly constructing a server.

4. The routing control method according to claim 1, wherein
when receiving the event which changes the destination address, the network controller primarily sets routing information of a downstream route which does not affect a communication being connected and sets, to routing information of an upstream route, the routing information in which the destination address has been changed such that the routing information is not received, and
after processing of changing the destination address has been completed, the network controller controls a state capable of receiving the routing information, in which the destination address has been changed, of the upstream route.

5. The routing control method according to claim 1, wherein the event which changes the destination address is issued based on a timing controlled by a scheduler.

6. A non-transitory computer-readable recording medium storing a routing control program for causing a computer to execute:
being executed by a device, causing the device to perform a routing control in a network in which a plurality of communication terminal and at least one server are connected through at least one router, the device having routing information of the at least one router in the network and a function to set and monitor the routing information of the at least one router in the network;
receiving an event which changes a destination address of the at least one server;
primarily controlling routing information which does not affect a communication being connected; and
after processing of changing the destination address has been completed, controlling routing information which affects the communication being connected.

7. The non-transitory computer-readable recording medium storing the routing control program according to claim 6, wherein the routing information is set and monitored by using a broadcast.

8. A non-transitory computer-readable recording medium storing a routing control program for causing a computer to execute:
being executed by a device, causing the device to perform a routing control in a network in which a plurality of communication terminal and at least one server are connected through at least one router, the device having routing information of the at least one router in the network and a function to set and monitor the routing information of the at least one router in the network;
receiving an event which changes a destination address of the at least one server;
primarily controlling routing information of a downstream route which does not affect a communication being connected;
setting, to routing information of an upstream route, the routing information in which the destination address has been changed such that the routing information is not received; and
after processing of changing the destination address has been completed, controlling a state capable of receiving the routing information, in which the destination address has been changed, of the upstream route.
